(19) United States
(12) Patent Application Publication
(10) Pub. No.: US 2004/0151098 A1
(43) Pub. Date: Aug. 5, 2004

(54) Data carrier, its manufacturing method, reproduction control method, and drive

(76) Inventors: Hideki Nagano, Yuki-gun (JP); Katsusuke Shimazaki, Toride-shi (JP); Tamotsu Iida, Tsuchiura-shi (JP); Akira Inaba, Kitasouma-gun (JP)

Correspondence Address: Oliff & Berridge, PO Box 19928, Alexandria, VA, 22320, US

(21) Appl. No.: 10/473,865

(22) PCT Filed: Mar. 4, 2002
(86) PCT No.: PCT/JP02/03340

(30) Foreign Application Priority Data
Apr. 4, 2001 (JP) 2001-105946

(51) Int. Cl. G11B 7/00

(52) U.S. Cl. 369/53.21

(57) ABSTRACT

There is provided a reproduction control method for used with a data carrier that includes a read only memory area that has concaves and convexes formed by injection molding, and records information to be reproduced, and a reproduction control layer, layered on the read only memory area, which changes a state through light irradiation, which method includes the steps of determining information which is prohibited from being reproduced among the information, and changing the reproduction control layer, through the light irradiation onto a position on the read only memory area corresponding to the information which is prohibited from being reproduced, from a reproduction permissible state that allows the information to be reproduced to a reproduction prohibition state that prevents the information from being reproduced. Also, the data carrier, its manufacturing method and driving method are provided.

### TECHNICAL FIELD

The present invention relates generally to reproduction control over a data carrier, and more particularly to control using optical means over a reproduction of a data carrier that has a read only memory area The present invention is suitable, for example, for reproduction control over an optical disc that mixes a read only memory (“ROM”) area that allows only a reproduction of pre-stored data, and a random access memory (“RAM”) area that may newly or additionally record data.

### BACKGROUND ART

Along with recent developments of computerization technology, a wide variety of small and large-capacity data carriers have been used. In particular, CD-ROMs and music CDs (“CD-DAs”) with a simple medium structure suitable for productivity achieve a manufacture cost per carrier lower than that of other data carriers, and are widely used as a data carrier for distribution.

However, these data carriers cause social problems in spread of piracy versions due to copies through write-once or rewritable optical storage media, such as Compact Disc-Recordables (“CD-Rs”) and Compact Disc-Rewritables (“CD-RWs”). In addition, there ame many cases where people do not abide by copyrights; for example, after a computer etc installs or copies data that has been recorded in a CD, as a CD-ROM that stores the original data appears on the second market. In order to avoid these problems, various countermeasures have been proposed, such as a reproducer that may identify a dedicated CD-ROM, control over distributed software by serial numbers, and copy protects using special formats, but effects have not been perfect. Moreover, a demand has existed for a prohibition of a reproduction of part or all of information in addition to piracy versions and used software.

### DISCLOSURE OF INVENTION

Accordingly, it is an object of the present invention to provide a novel and useful data carrier, its manufacture method, a reproduction control method, and drive, in which the above conventional disadvantages are eliminated.

More specifically, it is an exemplary object of the present invention to provide a reproduction control method, drive, data carrier and its manufacture, method, which may control a reproduction of a data carrier that includes an easily copiable ROM area.

In order to achieve the above objects, a reproduction control method as one aspect of the present invention for used with a data carrier that includes a read only memory area that has concaves and convexes formed by injection molding, and records information to be reproduced, and a reproduction control layer, layered on the read only memory area, which changes a state through light irradiation includes the steps of determining information which is prohibited from being reproduced among the information, and changing the reproduction control layer, through the light irradiation onto a position on the read only memory area corresponding to the information which is prohibited from being reproduced, from a reproduction permissible state that allows the information to be reproduced to a reproduction prohibition state that prevents the information from being reproduced. This reproduction control method selects arbitrary information to be prohibited from being reproduced among information recorded on the read only memory area on the data carrier including disc-shape and tape-shape record carriers, and irradiates light onto the reproduction control layer at a position corresponding to the information, thereby prohibiting a reproduction of the information (not in a sense of software but physically). A determination of information to be prohibited from being reproduced is not limited, for example, to a detection of unauthorized copy to the data carrier using an identifier unique to the carrier, etc. or case of so-called piracy version (in which the entire information is to be prohibited from being reproduced). For example, while plural pieces of information or entire information is recorded at one time for production convenience, unpaid information needs to be prohibited when a purchaser pays only part of plural pieces of information (for example, four pieces of music among information of ten pieces of music). A reproduction of part of information (such as violent scenes) needs to be prohibited according to other conditions, such as age of a purchaser, or for a sample, advertisement version.

The reproduction control layer uses a material that physically or chemically changes, upon a laser beam, preferably irreversibly. For example, the reproduction control layer is made of organic coloring matter that degenerates upon light irradiation, such as, for example, cyanine system coloring matters, squarylium coloring matters, polymetine system coloring matters such as azurenium system coloring matters, large ring aza-annulene such as phthalocyanine system coloring matters, and diothiol system coloring matters. Alternatively, the laser irradiation for reproduction prohibition may cause concaves and convexes formed on the board to deform, making reproduction impossible.

The data carrier may arrange control information corresponding to a file of a directory for each recording unit, and the changing step may set the control information into the reproduction prohibition state. The directory has a hierarchy (or tree structure). Where a rewritable data carrier may prohibit a reproduction of (for example, erase) a specific file, the original directory is freely rewritable so that the specific file is erased. The ROM medium is not rewritable, however, a reset of the entire directory has conventionally been needed. This reset is arduous; it is conceivable, for example, to provide plural types of directories that partially have folders and files that are prohibited from being reproduced, and to select a corresponding directory when a certain file is prohibited from being reproduced. However, this is ineffective since the number of directories to be prepared is enormous. Accordingly, this claim provides a method for easily controlling a reproduction of a file while leaving the tree structure and prohibiting file control information at a specific position from being reproduced. A unit of reproduction control may be, for example, a block or sector (for example, 2048 bytes) or an area divided in a sector. The latter case may use, for example, an identifier, such as a flag in each area, and control a reproduction based on whether the identifier is set to be reproduction prohibition. Thereby, a reproduction is effectively controlled. The recording unit may be a unit of an error correction code (“ECC”). The entire erasion or reproduction prohibition in a unit of ECC would prevent the ECC from recovering the reproduction-prohibited information. For example, when each sector has one ECC, the ECC works and recovers information that has been prohibited from being reproduced in controlling a reproduction of areas divided in the sector, and this case needs a change of a format and/or system.

The light irradiation step may use a reproducer for the data carrier. In this case, the reproducer conveniently serves as a reproduction prohibition unit. In prohibiting a reproduction, the irradiation preferably uses random pulse that has no correlation with information recorded on the ROM, and power enough high to cause the reproduction prohibition layer to change. However, there is no limit in pattern, such as continuous and intermittent patterns, as long as the laser irradiation is sufficient to make a reproduction impossible.

The data carrier may further include a random access memory area that may newly or additionally record information, and the reproduction control layer may be also layered on the random access memory area and made of organic coloring matter that enables recording to the random access memory area. In this case, the record carrier serves, for example, as a partial ROM disc that includes a ROM area and RAM area, and use for a reproduction control layer for the ROM area the organic coloring matter for the RAM area, which has been formed on the ROM area for manufacture convenience. It is unnecessary to newly form the reproduction control layer for the ROM area for effective use of resources.

A determination of information to be prohibited from being reproduced is based, for example, on a detection of an unauthorized copy to the data carrier using an identifier unique to the carrier. Alternatively, the historical information that includes an identifier unique to the drive and driving date and time may be newly or additionally recorded on the RAM area, and an authentication may use this information. When a determination of information to be prohibited from being reproduced utilizes the historical information and the RAM area is formed as a write-once type, security improves through unauthorized tamperproof and control over the RAM area using a residual capacity of the RAM area. Use of the reproduction control method may include, for example, a case where plural pieces of information or entire information is recorded at one time for production convenience, and unpaid information is prohibited when a purchaser pays only part of plural pieces of information (for example, four pieces of music among information of ten pieces of music), a prohibition of a reproduction of pan of information (such as violent scenes) according to other conditions, such as age of a purchaser, or for a sample, advertisement version, and a prohibition of a reproduction of information that is valid for a limited period of time, after the expiration date. The number of installs and reproductions may be restricted for various types of software (such as, for example, word processing, game, images, sounds, business, learning, and utility).

A drive of one aspect according to the present invention for driving a data carrier that includes a read only memory area that records information to be reproduced, and a reproduction control layer, layered on the read only memory area, which changes a state through light irradiation includes a reproduction part that reproduces the information, and a light irradiation part that changes the reproduction control layer, through the light irradiation onto a predetermined position on the read only memory area, from a reproduction permissible state that allows the information to be reproduced to a reproduction prohibition state that prevents the information from being reproduced, thereby prohibiting a reproduction of the information corresponding to the predetermined position. This drive serves as not only a reproducer conveniently but also a reproduction prohibition unit.

The data carrier further includes a random access memory area that may newly or additionally record information, and the reproduction control layer is also layered on the random access memory area and made of organic coloring matter that enables recording to the random access memory area, and wherein the drive further includes a recording part that records information into the random access memory area. In this case, the drive also serves as a recorder. It may include a detector part that detects respective reflection intensity levels of a reproduced signal from the read only memory area and a reproduced signal of information recorded on the random access memory areas and a determination part that determines, based on a decision by the detector part, whether the data carrier has the reproduction control layer. Thereby, the drive may identify whether the data carrier is a genuine product having a read only memory area or a piracy version. For example, a restriction of a reproduction from the read only memory area, etc. may improve security,

When the determination step in the above reproduction control method utilize the above historical information, the drive may further include a memory for recording an identifier unique to the drive, and a timer for including a driving date and time in the historical information. In addition, the drive may serve as a time reference function or time correction function through (for example, wireless or wire) communications with a time external to the drive, thereby preventing unauthorized change of a date and time, and improving security of the reproduction control method utilizing the historical information.

A data carrier of one aspect according to the present invention includes a read only area that is made of concave and convex pits formed by injection molding, and records information to be reproduced, a random access memory area that may newly or additionally record information, and a reproduction control layer, made of organic coloring matter and layered on the read only memory area and the random access memory area, which changes a state through light irradiation from a permissible state that allows a reproduction of the read only memory area and a record and reproduction of the random access memory area to a prohibition state that prohibits the reproduction of the read only memory area and the record and reproduction of the random access memory area, wherein the read only memory and random access memory areas are manufactured by a single stamper that has been produced by a mastering process using photoresist. While it has conventionally been necessary to change depths of the read only memory area and random access memory area, use of a single stamper facilitates manufacturing.

The random access memory area preferably has a guide groove having a width greater than that of the concave and convex pits of the read only memory area, thereby maintaining a wide margin. Also, preferably, the random access memory area has a guide groove, and wherein the organic coloring matter has a thickness of 90 nm or greater at bottoms of the guide groove of the random access memory area and the concave and convex pits of the read only memory area. A thickness smaller than 90 nm might highly possibly prevent reproduction control, or would disable additional writing function. An upper limit of the thickness depends-upon a type of the organic coloring matter and would be, for example, equal to or smaller than 230 nm, etc.

The reproduction control layer has a refractive index (or optical constant) n of, for example, 1.9 relative to a reproduction laser beam wavelength, thereby maintaining a desired signal characteristic. Therefore, organic coloring matter having a refractive index of about 1.8 is applicable other than CD-R coloring matter.

The stamper is produced by a method that includes, for example, the steps of forming photoresist with a thickness of 130 nm to 230 nm, and conducting laser cutting. As the photoresist has a thickness outside this range, recording becomes difficult. The stamper has an approximately uniform depth within a range enough to maintain electric characteristics of the data carrier. For example, it is regarded to have an approximately uniform depth within a range of distribution of about ±10% of concave and convex pits (for example, about ±10 nm).

Preferably, the read only memory area has a flat part (in addition to the concave and convex pits), wherein the reproduction control layer enables a signal to have 35%/a to 60% of percentage modulation of a signal amplitude to a maximum reflection intensity, the signal being generated according to existence and non-existence of optical interference with respect to a wavelength of reproduction laser beam between a bottom of the convex and concave pits and the flat part.

A method of another aspect according to the present invention for manufacturing a data carrier includes the steps of forming, with concave and convex pits formed by injection molding, a read only memory area that records information to be reproduced, forming a random access memory area that may newly or additionally record information, and making a reproduction control layer of organic coloring matter, and layering the reproduction control layer on the read only memory area and the random access memory area, the reproduction control layer changing a state through light irradiation from a permissible state that allows a reproduction of the read only memory area and a record and reproduction of the random access memory area to a prohibition state that prohibits the reproduction of the read only memory area and the record and reproduction of the random access memory area, wherein the steps of forming the read only memory and random access memory areas utilize a single stamper manufactured by a mastering process using photoresist.

The stamper is produced by a method that includes, for example, the steps of forming photoresist with a thickness of 140 nm to 220 nm, and conducting laser cutting. As the photoresist has a thickness outside this range, productivity deteriorates or recording/reproducing characteristics of the produced data carrier remarkably deteriorate. The stamper has an approximately uniform depth within a range enough to maintain electric characteristics of the data carrier. For example, it is regarded to have an approximately uniform depth within a range of distribution of about ±10% of concave and convex pits (for example, about ±10 nm).

Other objects and further features of the present invention will become readily apparent from the following description of the embodiments with reference to accompanying drawings.

### BRIEF DESCRIPTION OF DRAWINGS

FIG. 1 is a schematic side view of an optical disc as one exemplary data carrier which the present invention is applicable.

FIG. 2 is a schematic side view of a variation the optical disc of shown in FIG. 1.

FIG. 3 is a schematic side view of another variation the optical disc of shown in FIG. 1.

FIG. 4 is a schematic side view of the optical disc of shown in FIG. 3.

FIG. 5 is a schematic side view of still another variation the optical disc of shown in FIG. 1.

FIG. 6 is a partial schematic sectional view of an optical disc of example 1 according to the present invention.

FIG. 7 is a partial schematic sectional view of an optical disc of example 2 according to the present invention.

FIG. 8 is a partial schematic sectional view of an optical disc of example 3 embodiment according to the present invention.

FIG. 9 is a partial schematic sectional view of an optical disc of example 4 according to the present invention.

FIG. 10 is a partial schematic sectional view of a conventional optical disc as a comparative example to the optical discs shown in FIGS. 6 through 9.

FIG. 11 is a schematic block diagram of a drive 400 that executes an inventive reproduction control method.

FIG. 12 is a flowchart for explaining the inventive reproduction control process.

FIG. 13 is a schematic sectional view of a reproduction part of an optical disc of one embodiment according to the present invention

FIG. 14 is a table showing measurement results of the examples according to the present invention.

FIG. 15 is a typical view of an RF signal that measures the embodiments according to the present invention.

FIG. 16 is a view showing a directory structure for explaining an inventive file management method.

### BEST MODE FOR CARRYING OUT THE INVENTION

A description will now be given of a reproduction control method and drive 300 of one aspect according to the present invention, with reference to accompanying drawings. The data carrier to which the present invention is applicable broadly includes a disc-shaped record carrier, a tape-shaped record carrier, and other record carriers, and the reproduction method broadly covers light, magnetic, and other methods.

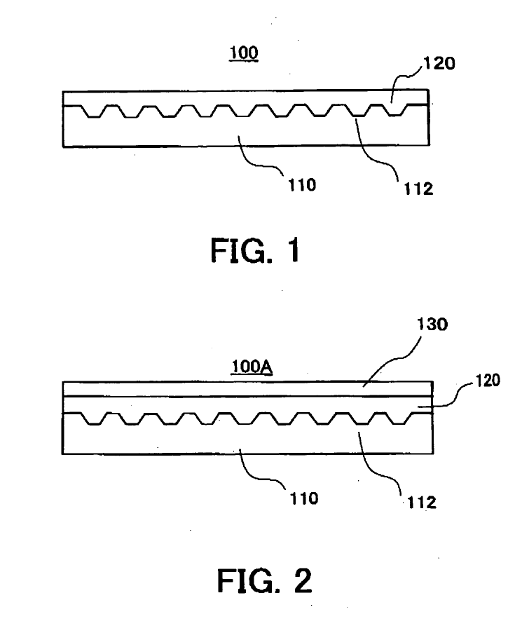

For example, the data carrier to which the present invention is applicable is made of an optical disc 100 that includes, as shown in FIG. 1, a board 110, and a reproduction control layer 120. Here, FIG. 1 is a schematic side view of the optical disc 100.

The board 110 is made of a transparent resin board material such as acryl, polycarbonate, polymetine methacrylate, polymethyl pentene, polyolefin, and epoxy. The board 110 may use photo-curing resin that forms a replica layer on a side of a transparent ceramic plate, such as glass. The board 110 is injection-molded using a stamper that includes pits representative of a pre-format signal, etc., and a read only memory area (ROM area) 112 is formed on its surface. The ROM area 112 has prerecorded data to be reproduced.

The reproduction control layer 120 is made of a material that increases temperature and varies its state when receiving light irradiation or other energy. In the instant embodiment, the reproduction control layer 120 in the initial state is at a reproduction permissible state that allows a reproduction (or readout) of data recorded on the ROM area 112, and turns, when receiving light irradiation of predetermined power, into a reproduction prohibition state that prohibits a reproduction of data recorded on the ROM area 112.

The reproduction control layer 120 uses a material that physically or chemically changes, preferably irreversibly, for example, when receiving a laser beam. Such a material includes, for example, organic matters that degenerate upon light irradiation, such as polymetine system coloring matters, such as cyanine system coloring matters, squarylium coloring matters, and azurenium system coloring matters, large ring aza-annulene such as phthalocyanine system coloring matters, and diothiol system coloring matters, or amoxphous-crystalloid phase change films, or low-melting alloy such as tin/silver/cupper alloy. These materials may blend OTTO or more types of these organic and inorganic materials.

When the reproduction control layer 120 is too thin or does not exist, no reproduction control or additional writing function is available, and thus it has an optimal thickness. For example, when the reproduction control layer uses organic coloring matters, the reproduction control layer 120 preferably has a thickness of 90 mm or greater at the deepest pit part. In addition, when the reproduction control layer 120 has small optical constant (or refractive index) even when the reproduction control layer 120 has a thickness of 90 nm or greater, a satisfactory signal is not available from the ROM area. Therefore, the optical constant of the reproduction control layer 120 preferably has 1.9 or greater. Moreover, it is preferable that the reproduction control layer 120 enables a signal to have 35% to 60% of percentage modulation of a signal amplitude to a maximum reflection intensity Itop, the signal being generated according to existence and non-existence of optical interference with respect to a wavelength (λ) of reproduction laser between a bottom of convex and concave part on the ROM area 112 and a flat part other than the concave and convex part. This provides the signal amplitude of the ROM area, and makes ROM reproduction control compatible with a RAM additional writing function.

If necessary, the optical disc 100 may be replaced with an optical disc 100A shown in FIG. 2 that layers an Al reflective layer 130. While the conventional CD-ROM is mainly made of the board 110 and aluminum (Al) reflective film 130, the optical disc 100A to which the invention is applicable includes the reproduction control layer 120, different from the conventional CD-ROM.

In response to the light irradiation onto a predetermined position with power enough to provoke a state change of the reproduction control layer 120 on the optical discs 100 and 100A shown in FIGS. 1 and 2, the reproduction control layer 120 turns into a reproduction prohibition state and information corresponding to the predetermined position cannot be read Out. The irradiated reproduction prohibition laser beam is random pulsed light that has no correlation with the ROM information, and has pulse density enough high to make a reproduction of the ROM information impossible, or should destroy beyond the error correction capability. This should destroy so that a bit error rate of ROM data is worse than 10⁻³ to 10⁻⁴, preferably down to 10⁻¹ to 10⁻².

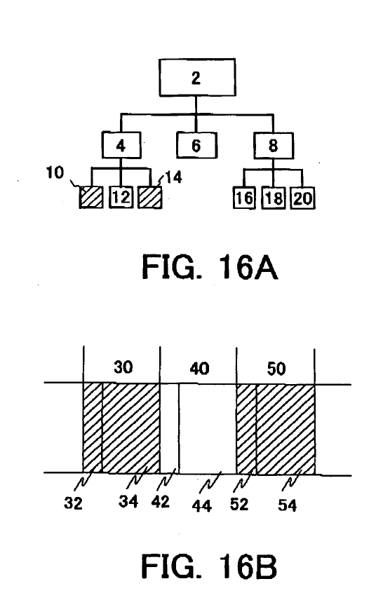

The present invention also provides a method for controlling files or folders (simply referred to as “files” hereinafter) in the optical disc 100 including the ROM area 112. Now suppose that the optical disc 100 has a directory shown in FIG. 16A.

As illustrated, the directory adopts a hierarchy or tree structure for managing files, which includes a root directory 2 and plural subdirectories 4 to 20.

The directory of one embodiment according to the present invention arranges control information for each recording unit, and more specifically it provides the subdirectories 4 to 20 with control information. Such an embodiment manages files by setting the reproduction control layer 120 corresponding to the control information to be a reproduction prohibition state.

Attempting to prohibit a reproduction of (for example, erase) a specific file, rewritable data carriers, such as a magneto-optical disc may freely rewrite an original directory so that the specific file is erased. On the other hand, a ROM medium cannot rewrite and resetting of the entire directory has conventionally been necessary. Since this reset is so arduous, it is conceivable to provide plural types of directories including folders and files that are partially prohibited from being reproduced, and to select a corresponding directory in order to prohibit a certain file from being reproduced. However, this method ineffectively requires enormous directories to be prepared.

Accordingly, the instant embodiment provides a method for easily controlling a reproduction of a file by prohibiting file control information at a specific position from being reproduced while leaving the tree structure. More specifically, for example, the reproduction control layer 120 corresponding to control information of subdirectories (or files) 10 and 14 is set to a reproduction prohibition state. The recording unit for reproduction control is, for example, a block or sector.

Preferably, the recording unit for reproduction control is a unit of error correction code (“ECC”). Entire erasion ox reproduction prohibition of the ECC unit prevents the ECC from recovering the reproduction-prohibited information.

A sector has a large capacity, for example, of 2048 bites in a CD-ROM, and a smaller recording unit may be selected. For example, as shown in FIG. 16B, areas 30 to 50 divided in a sector may be selected as a recording unit for reproduction control. Areas in this case include identifiers 32, 42 and 52, such as flags, at the head of areas 4, 44 and 54, such as data, and whether the identifier 32, 42 or 52 are set to a reproduction prohibition may control a reproduction of these areas. This may effectively control a reproduction of each sector. When a sector shown in FIG. 16B has one ECC, the ECC works and recovers information that has been prohibited from being reproduced in an attempt to control a reproduction of areas divided in the sector. Therefore, the structure shown in FIG. 16B needs a change of a format and/or system, for example, areas 30 through 50 have the ECC.

The present invention also covers a method that does not prohibit a reproduction of the entire ROM data area. For example, this may use a physical format that divides main ROM data when producing it, and record the divided data on a disc at a shuffled state. The shuffled arrangement order is also recorded on the ROM at a specific area. Only the specific area is destroyed in prohibiting a reproduction, whereby the main data cannot be substantially reproduced. A description will be given later of operations of optical discs 100 and 100A.

While the optical disc 100 may layer, on the board 110, a first intermediate layer, a reproduction control layer, a second intermediate layer, and a protection layer, it is optional to provide the first intermediate layer, second intermediate layer, and protection layer. Two optical discs 100 may be pasted together via an adhesive layer, as in a DVD standard. A disc having a RAM area may be pasted on a rear surface of the optical disc 100. It is also within a scope of the present invention to provide a lubricant layer to reduce damages associated with contacts with a head on an incident surface of recording/reproducing laser beam, and to print an opposite surface for protection and ornament of a lower layer.

The first and second intermediate layers include a reflective layer for improving a reflectance characteristic, a heat diffusion layer for prompting radiation of heat generated from a laser beam and dissolution of a recording layer, a second recording layer for facilitating reactions of the recording layer or for promoting reactions by optical excitation of the recording layer, a hard layer for separating the recording layer from external stress, and an air groove layer provided on a spacer, etc. The protective layer may be formed, for example, by screen-printing on the above intermediate layer an organic material, such as ultraviolet cure resin, thermoset resin, two-liquid-mixture cure resin, and room-temperature cure resin.

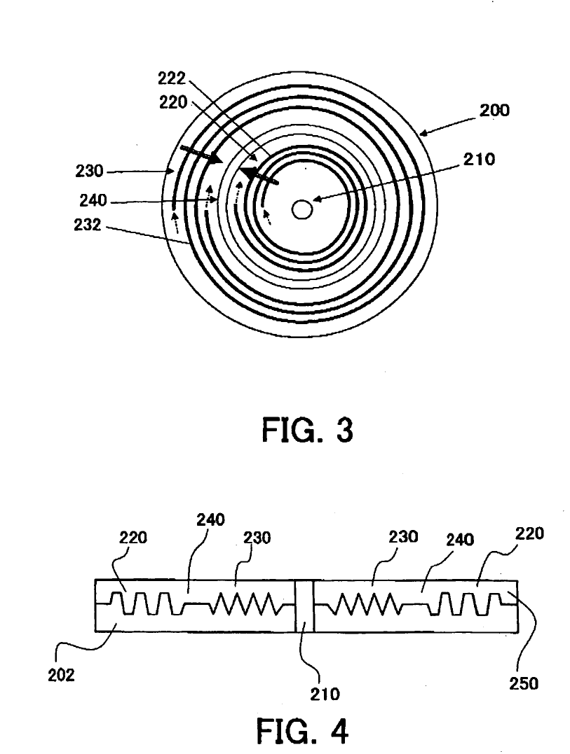

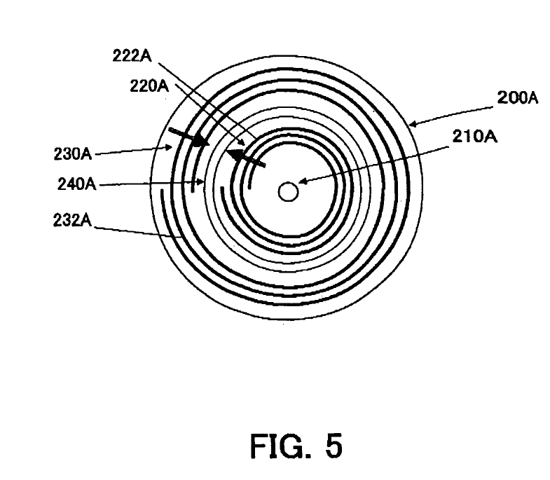

Referring to FIGS. 3 and 4, a description will now be given of optical discs (or partial ROM type optical discs) 200 and 200A as another data carrier to which the present invention is applicable, which mixes ROM and RAM areas. The optical discs 200 and 200A are characterized in a formation on the ROM area an organic coloring matter layer necessary for a recording operation on the RAM area and aggressive use of the layer as a reproduction control layer for the ROM area in order to facilitate a manufacture process. The partial ROM type disc covers a disc that forms on the same plate a pre-pit formed ROM area, and a data record area made of only address data pits and servo grooves, like a magneto-optical disc defined by the ISO standard, and a certain type, such as a DVD-RAM, which forms a ROM area for storing control and other information for the entire disc on its inner portion and a RAM area on its outer portion.

FIG. 3 is a schematic plane view of the optical disc 200, and FIG. 4 is a schematic sectional view of the optical disc 200. As shown in FIG. 3, the optical disc 200 has a diameter, for example, of 120 mm, and includes a center hole 210, an inner portion 220, an outer portion 230, and a buffer area 240 arranged between the inner portion 220 and outer portion 230. The inner portion 220 is assigned from the Center of the disc 200 to 60 mm, while the outer portion 230 is assigned from the buffer area 240 to 120 mm. As shown in FIG. 4, the optical disc 200 structurally layers the reproduction control layer 250 on the board 202.

A record track 222 is spirally formed around the center hole 210. The outer part 230 forms a record track 232 in a direction reverse to the record track 222. It is understood that as the optical disc 200 rotates clockwise, a record position of the record area 222 (or a position of a head 410 in a drive 400 for driving the optical disc 100 as described later) moves toward the outer side while a record position of the record area 232, which has a reverse spiral relationship to the record track 222, moves toward the inner side.

Since the optical disc 200 is thus configured such that the inner portion is recorded to the outside and the outer portion is recorded to the inside, the record areas are completely separated with independent address numbers beneficially. The optical disc 200 of the instant embodiment assigns the inner portion 220 with a write-once type or rewritable type record area (“RAM area”), and the outer portion 230 with a read only memory (or non-rewritable) area (“ROM area”).

The present invention is applicable to optical discs that form the ROM and RAM areas along one spiral track and assign consecutive addresses to it. However, such an optical disc would change addresses on the RAM area depending upon a length of ROM data, and calculate addresses of the RAM area while calculating the length of the ROM data in controlling recording actions. This would disadvantageously make undefined disc's control area that stores exchange and other information, resulting in the unstable recording and reproducing. On the other hand, independently produced and addressed RAM and ROM areas 220 and 230 fix a position of the RAM area 220 independent of a position of the ROM area 230. This may provide a stable exchange control etc., and stable recording and reproducing.

Structurally, a user formats the RAM area 220 and a manufacturer of the optical disc 200 formats the ROM area 230. This dramatically reduces a risk of unauthorized copy of data recorded on the ROM area 230 by a user.

When the inner portion 220 is configured, for example, as a DVD-RW, a disc-shaped polycarbonate resin (“PC”) board 202 is molded with an outer diameter of 120 mm, an inner diameter of 40 mm, and a thickness of 0.6 mm, on which a DVD-RW format is formed with lead-in data, addresses, track servo grooves, etc. A record layer is then formed on a signal surface from the diameter of 40 mm to the diameter of 78 mM on the PC board 202 by forming a transparent dielectric layer (not shown), a phase change record layer (or reproduction control layer 250), a transparent dielectric layer (not shown), an Al alloy reflective layer (not shown) in this order using a spatter method. Thus, the reproduction control layer 250 of the instant embodiment serves as the reproduction control layer for the ROM area 230, but as the phase change record layer for the R area. The reproduction control layer (or phase change record layer) are used for both the inner portion 230 and outer portion 250, and thus may be layered on the entire surface of the board 202, facilitating manufacturing and effectively utilizing resources.

Next, an ultraviolet (“UV”) protective film layer is formed by applying UV hardening protective resin with a thickness of about 10 in onto the reflective layer using a spin coat method, and hardening it with the LV radiation. The outer portion 130 is formed from the diameter of 80 mm to the diameter of 120 mm using a mask at the time of sputtering.

In configuring the inner portion as a DVD-R, the PC board 202 is molded with an outer diameter of 120 mm, an inner diameter of 10 mm, and a thickness of 0.6 mm, on which a DVD-R format is formed with lead-in data, user data record area, and lead-out data. A record layer is then formed by applying coloring matter solution onto a signal surface on the PC board 202 using the spin coat method and by layering an Au reflective layer (not shown) onto a dried record layer from the diameter of 40 mm to the diameter of 78 mm. The UV protective layer is then formed by applying UV protective resin with a thickness of about 10 μm onto the reflective layer using a spin coat method, and hardening it with the UV radiation. The outer portion, which will be described later, is formed from the diameter of 80 mm to the diameter of 120 mm using a mask at the time of spin coating. Even in this example, the reproduction control layer 250 similarly serves as the reproduction control layer for the ROM area 230, and as the record layer for the RAM area.

In configuring the inner portion 220 as a DVD-RAM, the disc-shaped PC board 202 is molded with an outer diameter of 120 mm, an inner diameter of 10 mm, and a thickness of 0.6 mm, on which a DVD-RAM format is formed with lead-in data, addresses, track servo grooves, etc. A record layer is then formed on a signal surface from the diameter of 40 mm to the diameter of 78 mm on the PC board 202 by forming a transparent dielectric layer (not shown), a phase change record layer (or reproduction control layer 250), a transparent dielectric layer (not shown), an Al alloy reflective layer (not shown) in this order using a spatter method. A UV protective film layer (not shown) is then formed by applying UV hardening protective resin with a thickness of about 10 μm onto the reflective layer using a spin coat method, and hardening it with the UV radiation. The outer portion, which will be described later, is formed from the diameter of 80 mm to the diameter of 120 mm using a mask at the time of sputtering. Of course, the inner portion 220 may be structured as a CD-R or a CD-RW. Even in this example, the reproduction control layer 250 similarly serves as the reproduction control layer for the ROM area 230, and as the record layer for the RAM area.

In configuring the outer portion 230 as a DVD-ROM, the outer portion is formed next to one of the above inner portions using a DVD-ROM format with lead-in data, user data area, and lead-out data An Al reflective layer (not shown) is then stacked onto the signal surface of the PC board 202 through the preformed reproduction control layer 250 from the diameter 82 mm to the diameter of 119 mm using a sputter method so that the reflectance may range from 45% to 50%. A UV protective film layer (not shown) is then formed by applying UV hardening protective resin with a thickness of about 10 μm onto the reflective layer using the spin coat method, and hardening it with the UV radiation. The outer portion 230 may, of course, be a music CD, a CD-ROM, a DVD-video, etc.

Broadly speaking, it is sufficient that the inner and outer portions 220 and 230 are assigned differently structured record areas. The record area of the different structure may be arbitrarily configured as, but not limited to, one of a group including a CD-R, DVD-R, music CD, CD-ROM, DVD-ROM, and DVD video.

An arbitrary combination of these two differently structured record areas may be advantageously mixed such that, for example, the ROM area 230 is recorded with a DVD-ROM format while the RAM area 220 is recorded with a CD-R format. It is noted that the outer portion 230 has a different format from that of the inner portion 220 such that an arrangement of lead-in part etc. may be incompatible, whether the format uses a CD or DVD system, because it is necessary to set a start position to an outer position for various types of formats that designate the start position.

Executions of recording and mastering for the ROM while considering these points would create a common, uniquely addressed disc that mixes the ROM and RAM areas 220 and 230.

A combination of the DVD-R, DVD-RW, DVD-RAM and DVD-ROM would not greatly change conventional drives since it has common formats and modulation/demodulation systems. In particular, a RAM area assigned to the inner portion 220 would enable the conventional drive to record.

The buffer area 240 is provided at a border between the ROM area 220 and the RAM area 230, the record tracks 222 and 232 extending in different spiral directions end here. The buffer area 240 is set to have a range enough wide to prevent generation of cross talk, preferably at least twice as wide as a larger track pitch out of both record areas.

The buffer area 240 is an undefined area in view of use, and preferably formed as mirror part that records nothing. A non-mirror structure may also serve as the buffer area 240, for example, by crossing the record tracks 222 and 232 since the crossed area is unusable.

While the buffer area may be formed as a mirror part up to an end of each of the record tracks 222 and 232, this case requires precise head positioning. Crossing both tracks does not require precise head positioning, advantageously facilitating manufacture.

The optical disc 200 in this embodiment has several advantages in a fixed rotary direction for drive's spindle motor and a smaller design change in the conventional drive.

Alternatively, a track arrangement may be simpler on the disc 200 by inverting a spindle motor in the drive. While record areas have spiral record tracks in the same direction from the inner portion to the outer portion in this case, a rotation for recording the outer portion inverts a recording direction from the outer portion to the inner portion. In other words, the reverse rotation for the outer portion would provide the same spiral direction with the same recording effects of the reverse spiral directions. FIG. 5 is a schematic plane view of such an optical disc. Those elements in FIG. 5 which are the same as corresponding elements in FIG. 3 are designated by the same reference numerals with capitals, and a duplicate description thereof will be omitted. The inner recording track 222A and outer recording track 232A extend in the same spiral direction. The buffer area 240A exists since record address numbers must be provided for the outer portion 230A from the outer side even for the same spiral direction.

Although the optical disc 200A shown in FIG. 5 includes the reproduction control layer, a sectional view of the optical disc 200A is similar to that of FIG. 4 and thus the illustration is omitted. In other words, even in the optical disc 200A, the reproduction control layer 250 serves as the reproduction control layer for the ROM area 230, and as the record layer for the RAM area.

A reverse rotation of a spindle motor as in the optical disc 200A would easily distinguish between the ROM and RAM areas without confusing them on the same plane. A switch of drive's operations between the RAM and ROM modes would reversely rotate the spindle motor. Since it is unlikely to always access the ROM area, the spindle motor may stop its rotation to save power by entering a sleep mode when there is no need of access. Such time isolation between an access to the ROM area and an access to the RA area would result in independent addressing to the RAM and ROM areas, more suitable for a ROM or RAM recording/reproducing system. The outer portion is addressed from the outer side by a reverse rotation of the spindle motor so that the address number increases towards the inner side. This is exactly the same as conventional reproducing of a ROM disc recorded from the inner side, except that a start position and the rotary direction of the spindle motor are reversed to those in the conventional ROM. On the other hand, the RAM area creates a lead-in area and a data record area from the inner side, for example, like a CD-R. This is exactly the same as a normal CD-R and compatible with the conventional additional recording system, such as multiple sessions. Recording at this time is also similar to the normal D-F drive.

An arrangement of the above ROM and RAM areas may be opposite, in which a normal standard format applies to the ROM area and the RAM area is recorded from the outer side. A data amount recorded in the ROM area determines a border between the ROM and RAM areas, and thus a usable record area is defined by overlap between a record area that extends from the inner side and a record area that extends from the outer side.

A wide variety of application examples are conceivable using the inventive data carriers and drive. Such inventive applications include, but are not limited to, for example, distributed media for a computer program and a mechanism for erasing information works for unauthorized use so as to prevent spread of unauthorized use. For example, communication means, such as the Internet, allows use of software such as computer programs, music and videos, which have been distributed using the ROM, and the RAM area is used to record and manage historical data For example, a combination of a medium that stores an independent ID and an additional writing function would manage a user's use status of distributed medium. For example, the inventive data carrier is used as a ticket, and held as a memorial, after use, to record a photograph, animation, etc. For example, they are used as distributed media that replace paper media for publications.

### EXAMPLES

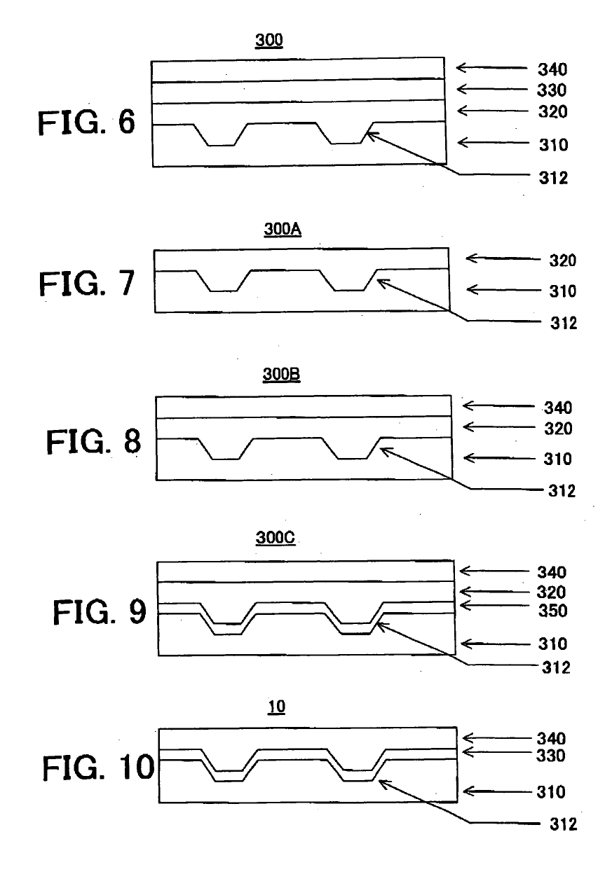

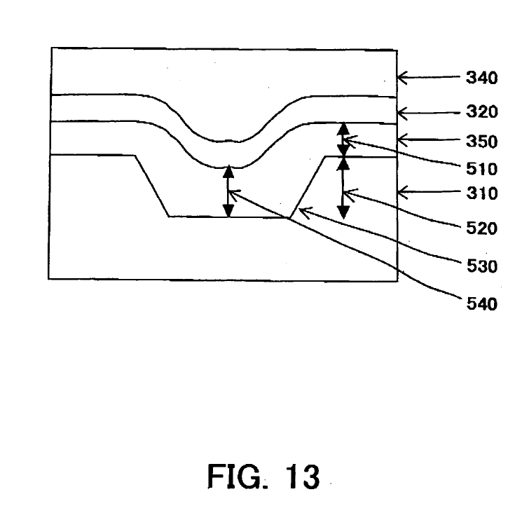

A description will be given of examples of the present invention with reference to FIGS. 6 through 15. The instant examples produced an optical disc including a reproduction control layer made of a cyanine system coloring matter and antidegradant, degenerated the reproduction control layer only at an arbitrary area with high power laser after confirming that the data is readable using the drive 400, and confirmed whether or not that portion is readable. In addition, a record area was formed on the same medium, and recording using laser was attempted. Moreover, it was confirmed whether an erasion effect lasts after an acceleration environment test.

### EXAMPLE 1

A disc-shaped transparent board 310 was produced by injection-molding polycarbonate resin, which has a diameter 120 mm, a formatted pattern and a center hole of a diameter of 15 mm at its center part. An overview of a plane structure of the obtained board 310 looked like FIG. 4. A pit row of EFM signals (or formatted pattern) 312 was formed from a radius 24 mm to 50 mm. A board was molded so that the pit has a depth 520 of 160 m and width 510 of 370 run, and the pit row 312 was spirally or concentrically formed with respect to a concentric circle of the center hole. The pit Tow 312 may be formed as wobbles, from which information is detectable about addresses of sectors, a base clock, and a type of the medium.

A guide groove 314 (not shown) with a width of 500 nm used for tracking of a recording laser beam was spirally or concentrically formed from a radius of 50 mm to 58 mm with respect to a concentric circle of the center hole. The guide groove 314 may be formed as a wobble groove, from which various pieces of information are detectable. The instant embodiment adopted a wobble groove.

The reproduction control layer 320 was then formed on the polycarbonate board 310. Cyanine system coloring matter of 19 weight part given by chemical formula 1 and antidegradant of 1 weight part given by chemical formula 2 were dissolved in high temperature 4-hydroxy-4-methyl-2-pentanone and 1, 1, 5-octafluoro-1-pentanol mixture solvent of 980 weight part. Obtained solution was filtered with a filter of 0.45 μm. Filtrate was applied onto the polycarbonate board 310 with a spin coat method, and a coloring matter layer was formed so that the reproduction control layer 320 had a film thickness 540 of 130 nm (at the deepest pit part). The measured optical constant n of the produced coloring matter layer was n=2.10. After the coated coloring matter was dried in the high temperature environment, an intermediate layer 330 of 50 nm, which was made of Ag/Au alloy, was formed with a sputtering apparatus on the coloring matter. After the intermediate layer 330 was formed, the protective layer 340 of a film thickness of 10 μm was formed by cleansing the coloring matter on the board 310 using alcohol, and finally applying the UV hardening resin using screen printing.

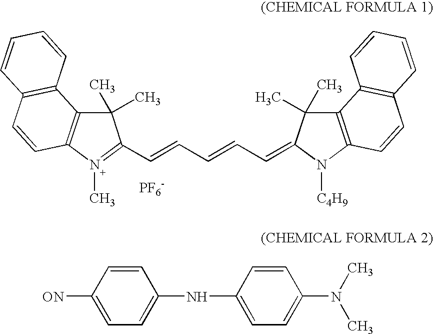

FIG. 6 shows a partial sectional view of thus obtained data carrier 300. As illustrated, the optical disc 400 has a structure that layers on the polycarbonate 310 the reproduction control layer 320, the intermediate layer 330 made of Ag/Au alloy, and the LUV hardening resin protective layer 340 in this order.

### EXAMPLE 2

Example 2 is different from Example 1 in eliminating a process subsequent to the sputtering step, and forming a partial ROM type optical disc 300A that has a layer structure consisting of the polycarbonate board 310 and the reproduction control layer 320. Other than that, this example used the same material and method as those of Example 1, and produced an optical disc 300B having a structure shown in FIG. 7.

### EXAMPLE 3

Example 3 provided the reproduction control layer 320 with a protective layer made of hydrophilic polymer in addition to Example 2, and formed a partial ROM type optical disc 300B including the polycarbonate 310, the reproduction control layer 320, and the protective layer 340. This example used a spin coat method as a layering method to form the reproduction control layer 320 through application on the board 310, dried them under a high temperature environment, and applied and dried 2% crosslinker added polyvinyl alcohol by the spin coat method. Then, UV irradiation followed to crystallize the protective layer 340 made of hydrophilic polymer and turn it into water and humidity resistance. Other than that, this example used the same material and method as those of Example 2, and produced an optical disc 300B having a structure shown in FIG. 8.

### EXAMPLE 4

Example 4 arranged a thin intermediate layer 350 made of inorganic material between the polycarbonate board 310 and the reproduction control layer 320 in addition to Example 3, and formed a partial ROM type optical disc 300C including the polycarbonate 310, the inorganic intermediate layer 350, the reproduction control layer 320, and the protective layer 340. This example formed the intermediate layer 330 made of Au with a thickness of 10 nm on the polycarbonate board 310 using the sputtering unit. Other than that, this example used the same material and method as those of Example 3, and produced an optical disc 300C having a structure shown in FIG. 9.

### EXAMPLE 5

After the polycarbonate board 310 was produced in a way similar to Example 1, cyanine system coloring matter 19 weight part given by chemical formula 3 and antidegradant 1 weight part given by chemical formula 2 were dissolved in high temperature 4-hydroxy-4-methyl-2-pentanone and 1, 1, 5-octafluoro-1-pentanol mixture solvent of 980 weight part. Obtained solution was filtered with a filter of 0.45 μm. Filtrate was applied onto the polycarbonate board 310 with a spin coat method, and a coloring matter layer was formed so that the reproduction control layer 320 had a film thickness 540 of 130 nm (at the deepest pit part). The measured optical constant n of the produced coloring matter layer was n=2.05. Other than that, this example used the same material and method as those of Example 1, and produced an optical disc 300B having a structure shown in FIG. 7.

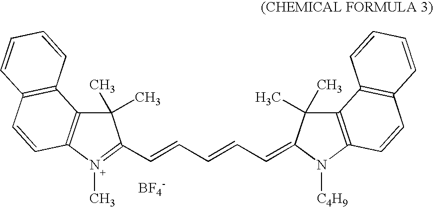

### EXAMPLE 6

After the polycarbonate board 310 was produced in a way similar to Example 1, cyanine system coloring matter of 19 weight part given by chemical formula 4 and antidegradant of 1 weight part given by chemical formula 2 were dissolved in high temperature 4-hydroxy-4-methyl-2-pentanone and 1, 1, 5-octafluoro-1-pentanol mixture solvent of 980 weight part Obtained solution was filtered with a filter of 0.45 μm. Filtrate was applied onto the polycarbonate board 310 with a spin coat method, and a coloring matter layer was formed so that the reproduction control layer 320 had a film thickness 540 of 150 nm (at the deepest pit part). The measured optical constant n of the produced coloring matter layer was a ˜2.05. Other than that, this example used the same material and method as those of Example 1, and produced an optical disc 300B having a structure shown in FIG. 7.

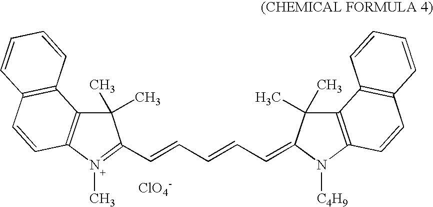

### EXAMPLE 7

After the polycarbonate board 310 was produced in a way similar to Example 1, cyanine system coloring matter of 19 weight part given by chemical formula 5 and antidegradant of 1 weight part given by chemical formula 2 were dissolved in high temperature 4-hydroxy-4-methyl-2-pentanone and 1, 1, 5-octafluoro-1-pentanol mixture solvent of 980 weight part. Obtained solution was filtered with a filter of 0.45 μm. Filtrate was applied onto the polycarbonate board 310 with a spin coat method, and a coloring matter layer was formed so that the reproduction control layer 320 had a film thickness 540 of 120=m (at the deepest pit part). The measured optical constant n of the produced coloring matter layer was n=2.15. Other than that, this example used the same material and method as those of Example 1, and produced an optical disc 300B having a structure shown in FIG. 7.

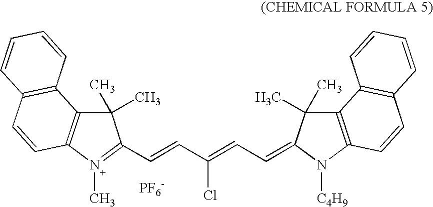

### EXAMPLE 8

After the polycarbonate board 310 was produced in a way similar to Example 1, cyanine system coloring matter of 19 weight part given by chemical formula 6 and antidegradant of 1 weight part given by chemical formula 2 were dissolved in high temperature 4-hydroxy-4-methyl-2-pentanone and 1, 1, 5-octafluoro-1-pentanol mixture solvent of 980 weight part. Obtained solution was filtered with a filter of 0.45 μm. Filtrate was applied onto the polycarbonate board 310 with a spin coat method and a coloring matter layer was formed so that the reproduction control layer 320 had a film thickness 540 of 130 μm (at the deepest pit part). The measured optical constant n of the produced coloring matter layer was n=2.15. Other than that, this example used the same material and method as those of Example 1, and produced an optical disc 300B having a structure shown in FIG. 7.

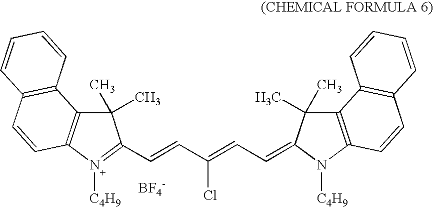

### EXAMPLE 9

After the polycarbonate board 310 was produced in a way similar to Example 1, cyanine system coloring matter of 19 weight part given by chemical formula 7 and antidegradant of 1 weight part given by chemical formula 2 were dissolved in high temperature 4-hydroxy-4-methyl-2-pentanone and 1, 1, 5-octafluoro-1-pentanol mixture solvent of 980 weight part. Obtained solution was filtered with a filter of 0.45 μm. Filtrate was applied onto the polycarbonate board 310 with a spin coat method, and a coloring matter layer was formed so that the reproduction control layer 320 had a fib thickness 540 of 140 μm (at the deepest pit part). The measured optical constant n of the produced coloring matter layer was n=2.05. Other than that, this example used the same material and method as those of Example 1, and produced an optical disc 300B having a structure shown in FIG. 7.

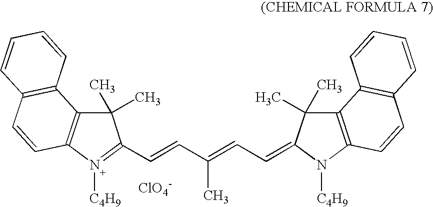

### EXAMPLE 10

After the polycarbonate board 310 was produced in a way similar to Example 1, cyanine system coloring matter of 19 weight part given by chemical formula 6 and antidegradant of 1 weight part given by chemical formula 2 were dissolved in high temperature 4-hydroxy-4-methyl-2-pentanone and 1, 1, 5-octafluoro-1-pentanol mixture solvent of 980 weight part. Obtained solution was filtered with a filter of 0.45 μm. Filtrate was applied onto the polycarbonate board 310 with a spin coat method, and a coloring matter layer was formed so that the reproduction control layer 320 had a film thickness 540 of 110 nm (at the deepest pit part). The measured optical constant n of the produced coloring matter layer was n=2.20. Other than that, this example used the same material and method as those of Example 1, and produced an optical disc 300B having a structure shown in FIG. 7.

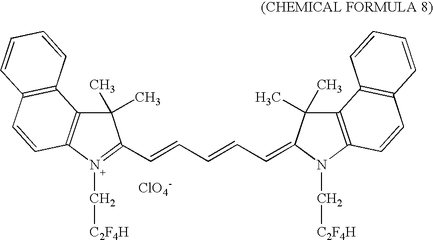

### COMPARATIVE EXAMPLE 1

No coloring matter was applied onto the polycarbonate board 310 that had been produced in a way similar to Example 1, and a sputtering unit made an intermediate layer 330 of Ag/Au alloy with 50 nm on the board. UV hardening resin was applied on the intermediate layer 330 using the screen printing, and the protective layer 340 was formed with a film thickness of 10 μm. An optical disc 10 thus obtained has a structure, as shown in FIG. 10, which layers the intermediate layer 330 made of an Ag/Au alloy and UV cured resin protective layer 340 in this order on the polycarbonate board 310.

### COMPARATIVE EXAMPLE 2

Example 2 formed, different from Example 1, a coloring matter layer so that the reproduction control layer had a film thickness 540 of 90 nm (at the deepest pit part). Other than that, this example used the same material and method as those of Example 1, and produced an optical disc 300B having a structure shown in FIG. 7.

### COMPARATIVE EXAMPLE 3

Example 2 formed, different from Example 10 a coloring matter layer so that the reproduction control layer had a film thickness 540 of 180 nm (at the deepest pit part). Other than that, this example used the same material and method as those of Example 1, and produced an optical disc 300B having a structure shown in FIG. 7.

### COMPARATIVE EXAMPLE 4

Example 2 forms, different from Example 10, a pit row of EFM signals 312 (or a formatted pattern) from a radius of 24 mm to a radius of 50 mm. A board was molded so that the pit has a depth 520 of 1.60 nm and width 510 of 300 μm, and the pit row 312 was spirally or concentrically formed with respect to a concentric circle of the center hole.

A guide groove 314 (not shown) with a width of 500 nm used for tracking of a recording laser beam was spirally or concentrically formed from a radius of 50 mm to 58 mm with respect to a concentric circle of the center hole. Other than that, this example used the same material and method as those of Example 1, and produced an optical disc 300B having a structure shown in FIG. 7.

### COMPARATIVE EXAMPLE 5

Example 2 forms, different from Example 10, a pit row of EFM signals 312 (or a formatted pattern) from a radius of 24 mm to a radius of 50 mm. A board was molded so that the pit had a depth 520 of 160 nm and width 510 of 370 nm, and the pit row 312 was spirally or concentrically formed with respect to a concentric circle of the center hole.

A guide groove 314 (not shown) with a width of 300 nm used for tracking of a recording laser beam was spirally or concentrically formed from a radius of 50 mm to 58 mm with respect to a concentric circle of the center hole. Other than that, this example used the same material and method as those of Example 1, and produced an optical disc 300B having a structure shown in FIG. 7.

### COMPARATIVE EXAMPLE 6

After the polycarbonate board 310 was produced in a way similar to Example 1, phthalocyanine coloring matter (“Super Green”) produced by Ciba-Geigy of 5 weight part vas dissolved in butyl ether of 195 weight part. Obtained solution was filtered with a filter of 0.45 μm. Filtrate was applied onto the polycarbonate board 310 with a spin coat method, and a coloring matter layer was formed with a film thickness of 120 nm (at the deepest pit part). The measured optical constant n of the produced coloring matter layer was n=1.80. Other than that, this example used the same material and method as those of Example 1, and produced an optical disc 300B having a structure shown in FIG. 7.

### COMPARATIVE EXAMPLE 7

A coloring matter of phthalocyanine coloring matter (“Super Green”) produced by Ciba-Geigy was formed on the polycarbonate board 310 produced in a way similar to Comparative Example 5 so that the deepest pit part is 80 nm. When the optical constant n of the produced coloring matter was measured, n was 180. Other than that, this example used the same material and method as those of Example 1, and produced an optical disc 300B having a structure shown in FIG. 7.

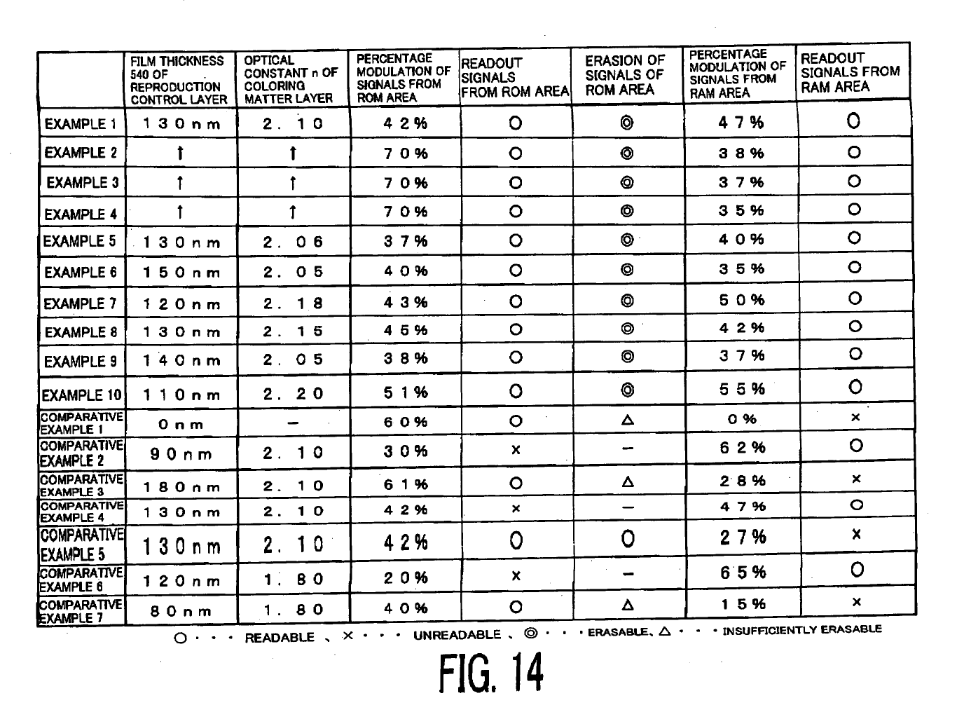

The optical discs obtained in the above Examples 1 through 10 and Comparative Examples 1 through 7 were rotated at a line velocity of 9.6 m/see using Nakamichi's optical data carrier measurement apparatus OMS2000, and signals recorded on the ROM portion were read out through semiconductor laser having a wavelength of 783 nm, a numerical aperture NA=0.55, and an output of 1.0 mW. Measurement results shown in FIG. 14 were obtained. Although Examples 1 through 10, and Comparative Examples 1, 1, 2, 5 and 6 have error ratios equal to or smaller than 0.1%, but the optical disc of Comparative Example 2 could not read due to the small signal amplitude. Therefore, it was clear that the coloring matter with a film thickness of 100 nm or smaller is unsuitable for the ROM media proposed by the present invention. While the optical disc of Comparative Example 5 had large percentage modulation, it was greatly asymmetrical or biased, and exhibited such bad jitter that it cannot be read. Therefore, a pit width must be at least narrower than the guide groove.

Then, it was rotated at a line velocity of 9.6 m/sec and the reproduction control layer 320 was turned into a reproduction prohibition state by randomly irradiating pulses having an output of 12.0 mW onto the ROM portion from a radius of 30 mm to 35 mm along the pit row 312.

Then, signals were again read out from the irradiated ROM portion at laser power having an output of 1.0 mW. As a result, the optical discs 300 to 300C of Examples 1 to 10 of the present invention could not reproduce signals from the areas irradiated by high power laser, but no change were seen at all in the reproduced signals from the regions other than the irradiated areas. There were few changes in reproduced signal of the optical data carrier by Comparative Example 1 throughout the carrier area in comparison with that prior to the laser irradiation. Thus, the reproduction control layer 250 clarified its effect.

Next, EFM signals were recorded with laser output of 12.0 mW at a pit row from a radius 50 mm to 58 mm on the optical record carriers obtained in the above Examples 1 through 10 and Comparative Examples 1 through 7 by rotating them at a line velocity of 9.6 m/sec using the same measurement apparatus. A reproducer used semiconductor laser having a wavelength of 788 nm, a numerical aperture NA=0.45, and an output value of 0.4 mW to read a signal from each optical disc, and a jitter meter measured a jitter value. As a consequence, reproduced signals from the optical record carriers of Examples of 1 to 10 and Comparative Examples 2 and 6 have percentage modulation of 40% or greater, and a jitter value of 10% or smaller, and an error ratio of 0.1% or smaller. A signal was not detected from the optical record carrier of Comparative Example 1 The optical record carriers of Comparative Examples 3 and 5 have small percentage modulation, and a jitter value of 20% or greater due to decrease of associative S/N ratio. This result clarified that the optical discs 300 to 300C served as a record carrier with good recording/reproducing characteristics. It was clarified that when the reproduction control layer 250 was too thick or too thin, it had an effect of reproduction prohibition but was unsuitable for additional writable media. In addition, Comparative Example 5 showed decreased SIN ratio due to shortage of recording sensitivity caused by too narrow guide groove. Therefore, a width of a guide groove should be at least wider than a pit width.

These optical data carriers were quietly stored for 1000 hours in a thermo-hygrostat of RH environment of at a temperature of 60° C. and humidity of 90%, and then read again. As a result any one of carriers of Examples 1 through 10 showed almost the same reproduction signal characteristics as that prior to the acceleration environment test. The above result clarified that the inventive data carriers had excellent reproduction signal quality and high security, and might enable an arbitrary area to be erased and written through high laser irradiation.

FIG. 14 summarizes these results. According to the thoughtful discussion from these results, aside from Comparative Example 1 that does not have the reproduction control layer 250, Comparative Examples do not necessarily serve as a data carrier that may control reproduction as proposed by the present invention although the reproduction control layer 250 exists.

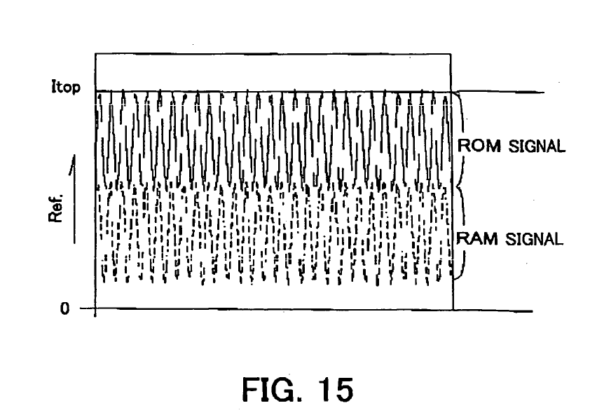

As a result of scrutiny of obtained signals, signals from the ROM area were different in signal level from those from the RAM area as shown in FIG. 15, and it was found that the following relationship established: (Reflectance of Mirror Part) □ (Signal Amplitude of ROM)+(Signal Amplitude of RAM)+(Bottom of Signal of RAM Area). In other words, it was found that as the signal amplitude of the ROM area increases, the signal amplitude of the RAM area decreases, whereby the carrier does not serve as a writable medium. On the other hand, as the signal amplitude of the RAM area increases, the signal amplitude of the ROM area decreases, whereby the carrier does not serve as a ROM medium for distribution purposes.

Furthermore, it was found that when the reproduction control layer 250 was excessively thin or did not exit, the reproduction control or additionally writing function was unavailable in any condition. Examples clarified that the reproduction control layer 250 had a thickness of 90 nm or greater at the deepest pit part. It was also found that even when the reproduction control layer 250 had a thickness of 90 nm or greater, the satisfactory ROM area was unavailable if the reproduction control layer 250 bad small optical constant n. Therefore, the reproduction control layer 250 must have the optical constant n 1.9 or greater. Even when these conditions were met, when the pit was wider the guide groove, a signal from either the ROM area or RAM area had so bad jitter that it could not be read.

It is conceivable to use coloring matter having small optical constant n by deepening the guide groove 314, but the guide groove 314 has Limits of its depth down to 220 nm in the normal process. Therefore, even coloring matter, which may be used for a CD-R, may not be used for the present invention.

As a result of that optical interference conditions were localized with respect to Examples 1 through 10 and Comparative Examples 1 through 7, it was found that all of the reproduction controllable and additionally writable data carriers according to the present invention might obtain a signal amplitude of from ROM area and reconcile the ROM reproduction control and RAM additional writing functions, when a signal has 35% to 60% of percentage modulation of a signal amplitude to a maximum reflection intensity Itop, the signal being generated according to the existence and non-existence of the optical interference with respect to a reproduction laser wavelength (λ) between bottoms of the convex and concave portions and tee flat part other than the convex and concave portions on the ROM area.

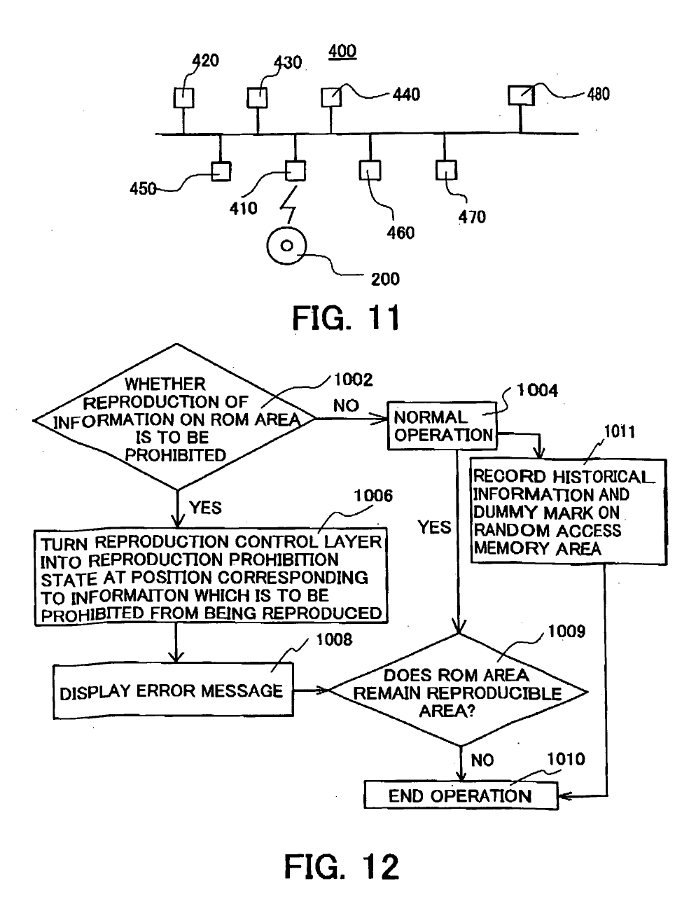

The reproduction control in the inventive data carrier has various applications. Concrete reproduction prohibition is conducted, for example, by the drive 400. The drive 400 includes, as shown in FIG. 11, a head 410, a CPU 420, a memory 430, a signal processor 440, a driving part 450, a drive controller 460, an interface part 470, and a timer 480, and accommodates the optical disc 100, 200, 300, etc. in a removable manner. A description will now be given of the optical disc 200 as an example. Here, FIG. 11 is a schematic block diagram of the drive 400 that executes the inventive reproduction control method.

The CPU 420 executes the inventive reproduction control method, and controls each part in the drive 400. The memory 430 includes, a non-volatile memory, such as a ROM, for storing operational programs and data for the system, and a volatile memory, such as a RAM, for temporarily storing data read from the optical disc 200 by the head 410 and necessary control programs. The signal processor 440 processes a signal which the head records in the optical disc 200, and a signal which the head reproduces from the optical disc 200. The driving part 450 includes a spindle motor for rotating the disc 200, a drive mechanism for driving the head, and other drive system, and is controlled by the drive controller 460, such as rotational control of a motor. The interface part 470 is connected to an external apparatus, such as a personal computer, as a host. Each component may use any structure known in the art, and a detailed description will be omitted here.

The CPU 420 executes the inventive reproduction control method, and controls each part in the drive 400. The memory 430 includes, a non-volatile memory, such as a ROM, for storing operational programs and data for the system, and a volatile memory, such as a RAM, for temporarily storing data read from the optical disc 200 by the head 410 and necessary control programs. The signal processor 440 processes a signal which the head records in the optical disc 200, and a signal which the head reproduces from the optical disc 200. The driving part 450 includes a spindle motor for rotating the disc 200, a drive mechanism for driving the head, and other drive systems, and is controlled by the drive controller 460, such as rotational control of a motor. The interface part 470 is connected to an external apparatus, such as a personal computer, as a host. The timer 480 is a clock to include drive date and time in historical information, as described later. It is possible to adjust unauthorized changes of date and time using (for example, wireless and wire) communications, Each component may use any structure known in the art, and a detailed description will be omitted here,

Referring to FIG. 12, a description will be given of the reproduction control process according to the present invention. Here, FIG. 12 is a flowchart for explaining the reproduction control process of the present invention. First, the CPU 420 determines whether a reproduction of information on the ROM area is to be prohibited based on historical information (identifier, the number of reproductions, reproduction time, and expiration date) recorded on the RAM area, residual capacity of the RAM area, or unique ID number of the optical disc 200 (step 1002).

It is conceivable to prohibit a reproduction of all of information when the optical disc 200 is a piracy version or resale product.

On the other hand, the CPU 420 may determine that part of information on the ROM area 230 is to be prohibited from being reproduced. While plural pieces of information or entire information may be recorded at one time for manufacture convenience, this case may be used, for example, for a system that prohibits a reproduction of information outside the authorized range. For example, when a user purchases the optical disc 200 that stores 10 pieces of popular music on the ROM area 230, but pays for four pieces of music, it is necessary to prohibit a reproduction of remaining six pieces of music. In addition, for the optical disc 200 that stores a game composed of plural stories or perfect story in the ROM area 230, it is necessary for minors to prohibit a reproduction of a violent story or scene. When the optical disc 200 is for advertisement, a reproduction should be partially prohibited. The number of installs and reproductions may be restricted for various types of software (such as, for example, word processing, game, images, sounds, business, learning, and utility).

When the CPU 420 determines that there is information to be prohibited from being reproduced, it irradiates light onto the reproduction control layer 250 at a position corresponding to the information to change it into the reproduction prohibition state (step 1006). An optical head having a laser wavelength 783 nm and a lens numerical aperture of 0.55 was used for pulsed light irradiation with a laser output of 12 mW in order to prohibit a reproduction of the ROM area on a disc that rotated at a line velocity of 9.6 m/s. A pulse pattern irradiated on the ROM portion had such a reproduction prohibition pit size on a disc that a pattern randomly mixed a mark of 0.5 μm to 2.0 μm and space. Thereby, a reproduction prohibition layer made of organic coloring matters formed random pits, and was at an overwritten state so as not to correlate with ROM consisting of convex and concave pits on the board. A signal reproduced from this portion was a disordered, random signal that made impossible a detection of an original ROM signal.

Moreover, when a reproduction prohibiting high-power laser beam was irradiated, concave and convex pre-pits on the board deformed in addition to a change of a reproduction prohibition layer, improving disorder of a reproduced signal. Thereby, as discussed in the above examples, a reproduction of the information becomes impossible. If necessary, an error message is indicated on a display (not shown) or an alarm is emitted from a speaker (step 1008).

The CPU 420 conducts a normal operation (step 1004) when determining that a change to a reproduction prohibition state (step 1006) ends and a RAM area remains (step 1009) or there is no information to be prohibited, allowing the head 410 on the ROM area 230 to reproduce data from it, and the head 410 on the RAM area 220 to reproduce data from and record data onto it. It ends an operation (step 1010) with a pretreatment that records historical information (such as an identifier, the number of reproductions, the reproduction time, and expiration time) into the RAM area or to adjust the residual capacity of the RAM area through recording of the historical information and a dummy mark (step 1011).

Further, the present invention is not limited to these preferred embodiments, and various variations and modifications may be made without departing from the scope of the present invention.

### INDUSTRIAL APPLICABLITY

Thus, the inventive reproduction control method and drive use a reproduction control layer that changes a state through light irradiation to control reproductions of information that has been previously recorded on a specific position on an easily copiable ROM area. In particular, as the reproduction control layer changes its state physically or chemically, it is securer than the software reproduction control and has enough security to prevent information leakage.

1. A reproduction control method for used with a data carrier that includes a read only memory area that has concaves and convexes formed by injection molding, and records information to be reproduced, and a reproduction control layer, layered on the read only memory area, which changes a state through light irradiation, said method comprising the steps of:
determining information which is prohibited from being reproduced among the information; and
changing the reproduction control layer, through the light irradiation onto a position on the read only memory area corresponding to the information which is prohibited from being reproduced, from a reproduction permissible state that allows the information to be reproduced to a reproduction prohibition State that prevents the information from being reproduced.

2. A reproduction control method according to claim 1, wherein the read only memory area is made of organic coloring matter.

3. A reproduction control method according to claim 1, wherein the data carrier arranges control information corresponding to a file of a directory for each recording unit, and
wherein said changing step sets the control information into the reproduction prohibition state.

4. A reproduction control method according to claim 3, wherein the recording unit is a unit of an error correction code.

5. A reproduction control method according to claim 1, wherein said light irradiation step uses a reproducer for the data carrier.

6. A reproduction control method according to claim 1, wherein the data carrier further includes a random access memory area that may newly or additionally record information, and the reproduction control layer is also layered on the random access memory area and made of organic coloring matter that enables recording to the random access memory area.

7. A reproduction control method according to claim 1, wherein the data carrier further includes a random access memory area that may newly or additionally record information, and
wherein said determining step uses historical information including an identifier that is recorded on the random access memory area and unique to the drive, and driving date and time.

8. A reproduction control method according to claim 7, wherein the historical information includes a reproduction condition for each data stored in the read only memory area, and said changing step includes the step of reading the historical information and prohibiting a reproduction of the date.

9. A reproduction control method according to claim 8, wherein the reproduction condition includes the number of reproductions of the data.

10. A reproduction control method according to claim 8, wherein the reproduction condition includes reproduction time of the data.

11. A reproduction control method according to claim 8, wherein the reproduction condition includes au expiration date of the data.

12. A reproduction control method according to claim 1, further comprising the step of determining whether or not each data stored in the read only memory area is to be prohibited, using a residual capacity of the random access memory area.

13. A reproduction control method according to claim 12, wherein an adjustment of the residual capacity utilizes a record of historical information and a record of a dummy mark.

14. A drive for driving a data carrier that includes a read only memory area that records information to be reproduced, and a reproduction control layer, layered on the read only memory area, which changes a state through light irradiation, said drive comprising:
a reproduction part that reproduces the information; and
a light irradiation part that changes the reproduction control layer, through the light irradiation onto a predetermined position on the read only memory area, from a reproduction permissible state that allows the information to be reproduced to a reproduction prohibition state that prevents the information from being reproduced, thereby prohibiting a reproduction of the information corresponding to the predetermined position.

15. A drive according to claim 14, wherein the data carrier further includes a random access memory area that may newly or additionally record information, and the reproduction control layer is also layered 6n the random access memory area and made of organic coloring matter that enables recording to the random access memory area, and
wherein said drive further comprises a recording part that records information into the random access memory area.

16. A drive according to claim 14, further comprising:
a detector part that detects respective reflection intensity levels of a reproduced signal from the read only memory area and a reproduced signal of information recorded on the random access memory area; and
a determination part that determines, based on a decision by said detector part, whether the data carrier has the reproduction control layer.

17. A drive according to claim 14, wherein the data carrier further includes a random access memory area that may newly or additionally record information, and
wherein said drive further comprises a timer and a memory for storing an identifier that is recorded on the random access memory area and unique to said drive.

18. A drive according to claim 14, wherein said drive serves to obtain time information from an apparatus external to said drive through communications.

19. A data carrier comprising:
a read only area that is made of concave and convex pits formed by injection molding, and records information to be reproduced;
a random access memory area that may newly or additionally record information; and
a reproduction control layer, made of organic coloring matter and layered on said read only memory area and said random access memory area, which changes a state through light irradiation from a permissible state that allows a reproduction of the read only memory area and a record and reproduction of the random access memory area to a prohibition state that prohibits the reproduction of the read only memory area and the record and reproduction of the random access memory area,
wherein the read only memory and random access memory areas are manufactured by a single stamper that has been produced by a mastering process using photoresist.

20. A data carrier according to claim 19, wherein the random access memory area has a guide groove having a width greater than that of the concave and convex pits of the read only memory area.

21. A data carrier according to claim 19, wherein the random access memory area has a guide groove, and
wherein the organic coloring matter has a thickness of 90 nm or greater at bottoms of the guide groove of the random access memory area and the concave and convex pits of the read only memory area.

22. A data carrier according to claim 19, wherein the reproduction control layer has a refractive index (n) relative to a reproduction laser beam wavelength equal to or greater than 1.9.

23. A data carrier according to claim 19, wherein the stamper is produced by a method comprising the steps of:
forming photoresist with a thickness of 140 nm to 220 nm; and
conducting laser cutting.

24. A data carrier according to claim 19, wherein the concave and convex pits of the read only memory area has a thickness of 130 nm to 230 nm.

25. A data carrier according to claim 19, wherein the read only memory area has a flat part, and
wherein said reproduction control layer enables a signal to have 35% to 60% of percentage modulation of a signal amplitude to a maximum reflection intensity, said signal being generated according to existence and non-existence of optical interference with respect to a wavelength of reproduction laser beam between a bottom of the convex and concave pits and the flat part.

26. A method for manufacturing a data carrier, comprising the steps of:
forming, with concave and convex pits formed by injection molding, a read only memory area that records information to be reproduced;
forming a random access memory area that may newly or additionally record information; and
making a reproduction control layer of organic coloring matter, and layering said reproduction control layer on said read only memory area and said random access memory area, said reproduction control layer changing a state through light irradiation from a permissible state that allows a reproduction of the read only memory area and a record and reproduction of the random access memory area to a prohibition state that prohibits the reproduction of the read only memory area and the record and reproduction of the random access memory area,
wherein said steps of forming the read only memory and random access memory areas utilize a single stamper manufactured by a mastering process using photoresist.

27. A method according to claim 26, the stamper is produced by a method comprising the steps of:
forming photoresist with a thickness of 140 n to 220 nm; and
conducting laser cutting.
